(19) United States
(12) Patent Application Publication
(10) Pub. No.: US 2004/0251233 A1
(43) Pub. Date: Dec. 16, 2004

(54) Method for the production of a lens

(76) Inventors: Frank Singer, Regenstauf (DE); Guido Weiss, Regensburg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/484,599

(22) PCT Filed: Jul. 24, 2002
(86) PCT No.: PCT/DE02/02714

(30) Foreign Application Priority Data
Jul. 24, 2001 (DE) 101 35 872.5

(51) Int. Cl. C03B 19/14

(52) U.S. Cl. 216/26; 216/2

(57) ABSTRACT

In order to produce aspherical lenses on a semiconductor material, it is proposed to transfer the structure of a photoresist spherical cap to the underlying semiconductor substrate with the aid of a reactive ion etching method. In this case, use is made of a gas component which etches the photoresist and a further gas component which etches the underlying semiconductor substrate. The ratio of the gas flows is varied during the etching operation. The result is an aspherical lens whose measured cross-sectional profile (12) has only small errors (14) from an ideal curve (13).

The invention relates to a method for producing a lens, in particular made of a semiconductor material, such as silicon, for example.

Such lenses made of silicon are used for example for focusing the beam pencil of a laser which emits in the infrared wavelength range onto a point. In order to couple the laser beam pencil into an optical fiber as far as possible without any losses, or in order to obtain a high resolution when writing to or reading from a magneto-optical storage medium, it is necessary for the beam pencil to be focused as precisely as possible.

A method used for producing the lenses must therefore lead to lenses which comply with the specification with high accuracy. In addition, a method of this type is intended as far as possible to use the processes known from the processing of semiconductor materials.

Taking this prior art as a departure point, the invention is based on the object of specifying an economical and precise method for producing lenses made of a semiconductor material.

This object is achieved according to the invention by means of a method having the following method steps:

formation of a spherical segment-like mask on a substrate; and

transfer of the structure of the mask to the underlying substrate with the aid of a dry etching method based on a gas component which predominantly etches the substrate and a further gas component which predominantly etches the mask.

By means of this method, the structure of the mask is transferred to the underlying substrate. Accordingly, the form of the lens is determined by the structure of the mask. It has been shown that high-precision lenses can be produced by this method. Furthermore, only processes which are usually used in the processing of semiconductor materials in semiconductor technology are employed in this method. Therefore, it is possible to have recourse to the customary process steps, and there is no need for any additional installations for producing the lenses.

The dependent claims relate to further advantageous refinements of the method.

The invention is explained in detail below with reference to the accompanying drawing, in which:

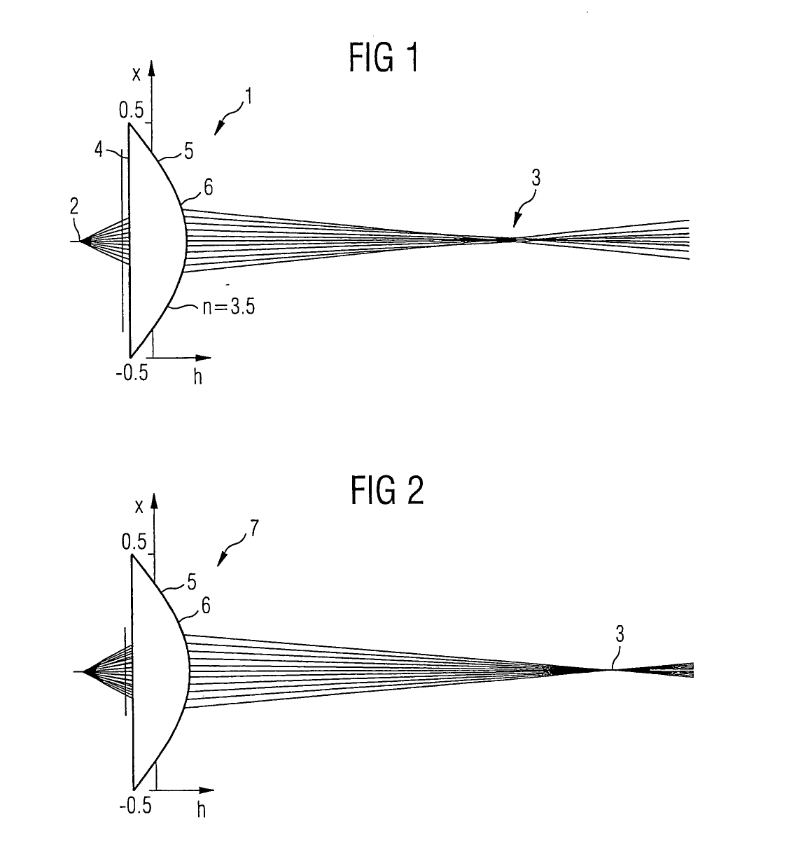

FIG. 1 shows a diagrammatic illustration of a cross section through a silicon lens with a spherical profile; and

FIG. 2 shows a diagrammatic illustration of a cross section through a silicon lens with an aspherical profile; and

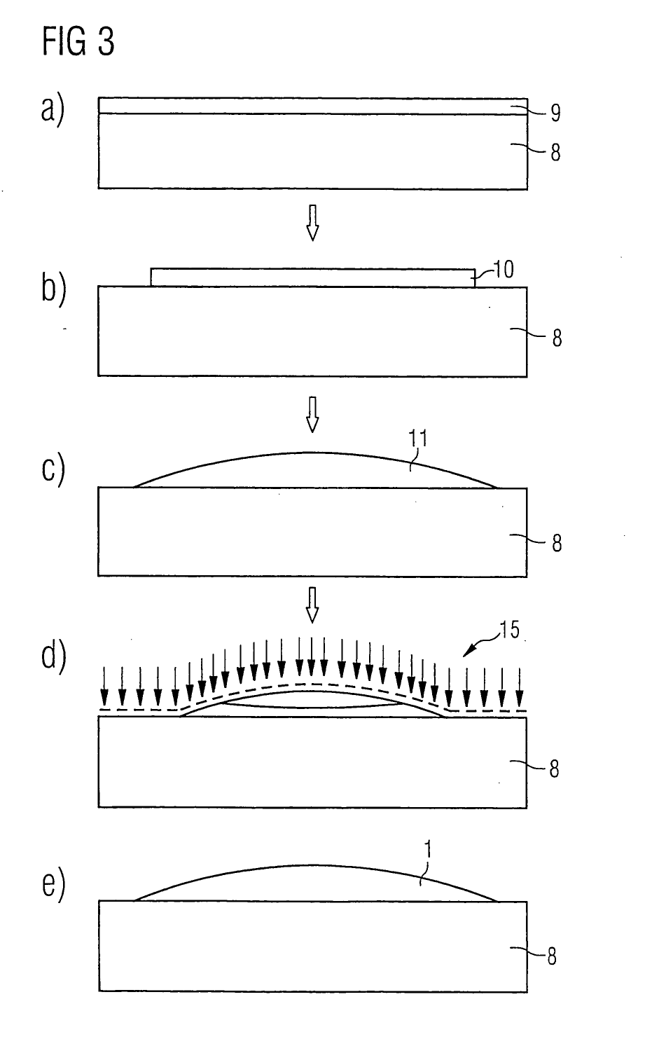

FIGS. 3a to 3e show a diagrammatic step by step illustration of a method sequence for producing a silicon lens;

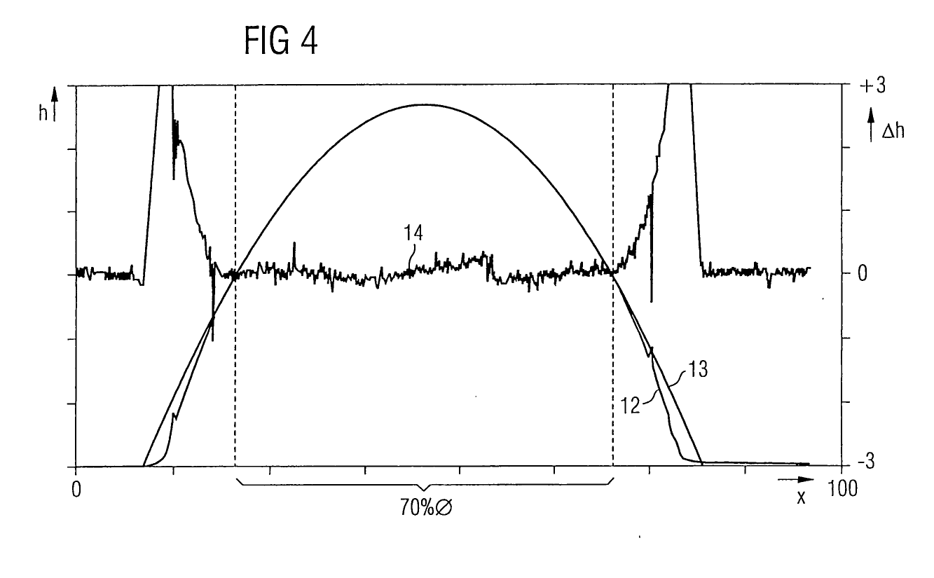

FIG. 4 shows a diagram with the measured profile of an aspherical lens and the deviation of the measurement curve from an ideal profile fitted to the measurement curve.

FIG. 1 illustrates a cross section through a lens 1 produced from silicon, which lens serves for concentrating light emerging from a radiation source 2 as far as possible onto a focus 3. The lens 1 illustrated in FIG. 1 has a planar rear side 4 and a front side 5, which is formed spherically in the region of the beam path—that is to say in the region of a beam area 6. This means that the front side 5 has a cross-sectional profile in the shape of a circle arc in the region of the beam path.

In the case of the lens 7 illustrated in FIG. 2, by contrast, the front side 5 is formed aspherically. This means that the lens 6 has a cross-sectional profile that deviates from a circle arc.

Generally, the height h of the beam area 6 as a function of the distance x from the optical axis is defined by the following formula:

$$h ( x ) = H - \frac{R}{k + 1} \times ( 1 - \sqrt{1 - \frac{( k + 1 ) \times {x}^{2}}{{R}^{2}}} )$$

where R is the radius and k is the aspherical factor. If the aspherical factor is k=0, the beam area 6 is formed spherically. By contrast, if k≈0 holds true for the aspherical factor, the beam area 6 is aspherical.

In order to produce the spherical lens 1 and the aspherical lens 7, in accordance with FIG. 3a, firstly a photoresist layer 9 is applied to a substrate 8, for example made of silicon, exposed and developed, so that individual photoresist cylinders 10 (FIG. 3b) remain on the substrate 8. Afterward, the substrate 8 with the photoresist cylinders 10 is subjected to thermal treatment for a time of between 0.5 and 1 hour at temperatures of around 200° C. As a result, the photoresist cylinder 10 is rounded to form a photoresist spherical cap 11 (FIG. 3c), the structure of which is transferred to the underlying substrate 8 with the aid of an anisotropic etching method (indicated by the arrows 15 in FIG. 3d). As a result, a lens 1 is formed from a part of the substrate 8 (FIG. 3e). The rest of the substrate 8 may subsequently be thinned for example by mechanical means or be completely removed from the lens 1.

An appropriate etching method is, in particular, reactive ion etching. What are also suitable in addition are etching methods such as anodically coupled plasma etching in a parallel plate reactor, triode reactive ion etching, inductively coupled plasma etching, reactive ion beam etching or similar methods which permit the use of a plurality of gas components with different selectivity with respect to the photoresist layer 9 and the substrate 8.

This is because the plasma reactor must contain a gas component which removes the photoresist spherical cap 11 and a further gas component which etches back the substrate 8. If the substrate 8 is produced from silicon, oxygen may be used for the gas component which etches the photoresist spherical cap 11. Sulfur hexafluoride, for example, is suitable as the gas component which etches back the substrate 8 made of silicon. In this case, the radius of the beam area 6 can be set by means of the ratio of the gas flows of the two etching gas components.

In order to produce the aspherical lens 1, the ratio of the gas flows is kept constant. In this case, the radius of the beam area 6 is smaller, the larger the gas flow of sulfur hexafluoride is in relation to the oxygen gas flow.

The beam area 6 of the aspherical lens 7 can also be etched by altering the ratio of the two gas flows during the etching operation. One example for the control of the gas flows is specified in Table 1.

TABLE 1

| Step | O₂/sccm | SF₆/sccm | Duration/s |
|---|---|---|---|
| 1 | 10 | 15.3 | 10 |
| 2 | 10 | 15.3 | 1600 |
| 3 | 9.9 | 15.6 | 150 |
| 4 | 9.9 | 15.9 | 150 |
| 5 | 9.8 | 15.9 | 150 |
| 6 | 9.8 | 16.2 | 150 |
| 7 | 9.7 | 16.2 | 150 |
| 8 | 9.7 | 16.3 | 150 |
| 9 | 9.6 | 16.3 | 150 |
| 10 | 9.6 | 16.4 | 150 |
| 11 | 9.5 | 16.4 | 75 |
| 12 | 9.5 | 16.5 | 75 |
| 13 | 9.4 | 16.5 | 75 |
| 14 | 9.4 | 16.6 | 75 |
| 15 | 9.3 | 16.6 | 75 |
| 16 | 9.3 | 16.7 | 75 |
| 17 | 9.2 | 16.7 | 75 |
| 18 | 9.2 | 16.8 | 75 |
| 19 | 9.1 | 16.8 | 75 |
| 20 | 9.1 | 16.9 | 75 |
| 21 | 9 | 16.9 | 150 |
| 22 | 9 | 17 | 150 |
| 23 | 8.9 | 17 | 150 |
| 24 | 8.9 | 17.1 | 150 |

Finally, FIG. 4 shows a measured profile of an aspherical lens 7, having an aspherical factor of −4, a radius R of 594.3 μm, a height H of 37.3 μm and a diameter of 440.6 μm. The measured cross-sectional profile 12 was recorded with the aid of a laser which scans the front side 5. In this case, a respective height measured value was recorded in each case at a distance of 1 μm. A fit curve 13 in the form of a hyperbolic function with the aspherical factor of −4 was matched to the measured cross-sectional profile 12. The difference between the cross-sectional profile 12 and the fit curve 13 is illustrated by an error curve 14 in FIG. 4. In order to determine the fit error, the fit errors at the measurement points were squared and summed. A fit error of 3 μm² resulted. However, only the beam area 6, that is to say approximately 40% of the diameter of the lens 7, was evaluated in this case.

The measurement shows that, in particular, aspherical lenses 7 can be produced with high accuracy by the method described.

1. A method for producing a lens (1, 7) having the following method steps:
formation of a rounded mask (11) on a substrate (8) and
transfer of the structure of the mask (11) to the underlying substrate (8) with the aid of a dry etching method based on a gas component which predominantly etches the substrate (8) and a further gas component which predominantly etches the mask (11).

2. The method as claimed in claim 1, in which a reactive ion etching method is used as the etching method.

3. The method as claimed in claim 1, in which, during the etching operation, the ratio of the gas flows of the gas component which predominantly etches the substrate (8) and of the gas component which predominantly etches the mask (11) is varied in order to produce an aspherical lens.

4. The method as claimed in claim 3, in which, during the etching operation, the ratio of the gas flows of the gas component which predominantly etches the substrate (8) and of the gas component which predominantly etches the mask (11) is lowered in order to produce an aspherical lens.

5. The method as claimed in claim 1, in which a substrate based on silicon is used.

6. The method as claimed in claim 1, in which, in order to produce the mask (11), firstly a photoresist layer (9) is applied to the substrate (8) and is subsequently patterned.

7. The method as claimed in claim 6,
in which the structures (10) of the photoresist layer (9) are rounded by means of a thermal treatment.

8. The method as claimed in claim 1, in which oxygen is used for the gas component which predominantly etches the mask (11) and sulfur hexafluoride is used for the gas component which predominantly etches the substrate (8).
